(19) United States
(12) Patent Application Publication
(10) Pub. No.: US 2010/0243828 A1
(43) Pub. Date: Sep. 30, 2010

(54) STAND COLUMN, IN PARTICULAR MUSIC STAND COLUMN OR MICROPHONE STAND COLUMN

(75) Inventors: Helmut LIPPERT, Breitenbrunn (DE); Peter REICHERT, Urspringen (DE)

Correspondence Address: GREENBLUM & BERNSTEIN, P.L.C., 1950 ROLAND CLARKE PLACE, RESTON, VA, 20191, US

(73) Assignee: KOENIG & MEYER GMBH & CO. KG, Wertheim (DE)

(21) Appl. No.: 12/729,921

(22) Filed: Mar. 23, 2010

(30) Foreign Application Priority Data
Mar. 27, 2009 (EP) 09 004 447.0

(51) Int. Cl. F16M 11/26

(52) U.S. Cl. 248/157

(57) ABSTRACT

A stand column includes two tubes having longitudinal axes and curved tube walls surrounding the longitudinal axes. The two tubes include an inner tube guidable in a telescoping manner in an outer tube. A clamping device is structured and arranged to fix the inner tube in various positions with respect to the outer tube, and includes at least one rolling element with a rotational axis oriented parallel to a normal to the longitudinal axes. The at least one rolling element is positioned between at least one clamping body arranged on one of the two tubes and the other of the two tubes, and has a circumferential wall with a curvature parallel to the rotation axis that is adapted to a curvature of the other tube.

### CROSS-REFERENCE TO RELATED APPLICATIONS

The present application claims priority under 35 U.S.C. §119 of European Patent Application No. EP 09 004 447.0, filed on Mar. 27, 2009, the disclosure of which is expressly incorporated by reference herein in its entirety.

### BACKGROUND OF THE INVENTION

1. Field of the Invention

The invention relates to a stand column, in particular, a music stand column or microphone stand column, with two tubes, i.e., an inner tube guided in an outer tube in a telescoping manner, and a clamping device, with which the inner tube can be fixed in various positions with respect to the outer tube. The two tubes respectively have a longitudinal axis and curved tube walls surrounding the longitudinal axis.

2. Discussion of Background Information

During musical performances it is often necessary to place the music (sheet music) needed by a musician on a music stand. This music stand should be adjustable in height so the music can be seen well by the musician. The musician also often needs a microphone, which is fixed on a stand. The height of the microphone should also be adjustable in order to render possible the best possible amplification of the musical performance.

It is therefore known with music stands to equip the stand column with at least two telescoping tubes. A screw is then attached to the outer tube, which screw acts in a clamping manner on the inner tube when screwed in.

However, this has the disadvantage that two hands are needed to adjust the height of the stand column, i.e., one hand to hold the inner tube and the other hand to loosen the screw. After the height has been changed, the screw must be tightened again. Another embodiment that is often used in the field of microphone stands operates with a cone that is clamped against the inner tube with a connection nut. Two hands are also necessary here to make an adjustment.

### SUMMARY OF THE INVENTION

Embodiments of the invention render possible a single-handed adjustment in a convenient manner.

According to these embodiments, a music stand column or microphone stand column of the type mentioned at the outset includes a clamping device having at least one rolling element with a rotation axis parallel to a normal to the longitudinal axis. The rolling element is arranged between a clamping body arranged on one tube and the other tube, and has a circumferential wall with a curvature parallel to the rotation axis, which is adapted to the curvature of the other tube.

With an embodiment of this type, the length of the stand column can be easily changed by loosening the clamping device. This can be carried out with the same hand that also holds the one tube. The clamping device operates with friction force. The clamping body presses on the rolling element. In turn, the rolling element bears against the other tube. The friction between the rolling element and the other tube on the one hand and the rolling element and the clamping body on the other hand prevents a reciprocal alignment of the two tubes from being changed when the clamping device has become active. In order to loosen the clamping device, the clamping body needs only to be displaced a small distance so that the friction is reduced. Due to the curved circumferential wall of the rolling element, a relatively large contact zone results between the rolling element and the other tube. This contact zone extends over virtually the entire axial length of the rolling element. This results in a relatively large area over which the friction force can act. Thus, relatively large forces can be applied without making the local compressive stresses excessively large. This keeps the risk low that the rolling element will deform the other tube. This risk exists, for example, with the use of spherical rolling elements, which bear against the other tube as it were only with a punctiform contact surface and therefore are not very suitable for tubes with a round cross section.

Preferably, several clamping bodies are provided, the circumferential walls of which respectively follow the curvature of the other tube. The clamping force is thus distributed in the circumferential direction. The curvature of the other tube does not need to be identical over the entire circumference thereby. Sections with different curvatures can also alternate. In this case, the curvature of the circumferential wall of the clamping body must be respectively adapted to the curvature of the corresponding section of the tube.

In a preferred embodiment, the other tube has a circular cross section and the curvature of the circumferential wall of the rolling element follows a circular line. This embodiment has the advantage that the inner tube and the outer tube can be fixed in any desired rotational angle position to one another, so that a music stand or also a microphone can be turned in a desired direction.

Preferably, the clamping body has a mounting surface for each rolling element, which mounting surface encloses an acute angle with the longitudinal axis and which has a curvature that is adapted to the curvature of the circumferential surface of the rolling element. In a longitudinal section, the clamping body has a conical area locally. When the clamping body is moved, it presses the rolling element increasingly against the other tube and thus increases the friction force in order to achieve a fixing of inner tube and outer tube relative to one another. At the same time, however, the mounting surface of the clamping body follows (in the circumferential direction) the curvature of the rolling element, so that the rolling element is also acted on with the clamping force on the side facing away from the other tube not only in a punctiform manner, but over a relatively large area. The rolling element is thus clamped over virtually its entire axial length between the clamping body and the other tube.

Preferably, the tube on which the clamping body is arranged or an insert connected thereto forms a holder for the rolling element. The rolling element is thus held on the tube undetachably. It is displaced jointly with the tube and the clamping body, so that the assignment between clamping body, rolling element and tube always remains such that a clamping fixing between the inner tube and the outer tube can be produced.

Preferably, the rolling element is made of a plastic. A plastic is generally somewhat softer than a metal. When the clamping body is then displaced such that it clamps the rolling element between itself and the other tube, the rolling element can be somewhat deformed so that the originally approximately linear mounting region widens to form a surface. This further improves the clamping.

It is preferable that the rolling element is made of polyurethane or a plastic with the same recovery behavior as polyurethane. The rolling element can then easily be deformed when the clamping body acts thereon, i.e., it is somewhat flattened in order to form a larger contact zone between the other tube on the one hand and the mounting surface of the clamping body on the other hand. When the clamping force is reduced, the rolling element returns to its rotationally symmetrical form again, i.e., it forms a roller again that bears against the other tube and can unroll there.

Preferably, the clamping body is arranged on the inner tube and the rolling element bears from inside against the outer tube. This is a relatively space-saving embodiment.

Preferably, the clamping body is connected to a release device, which is arranged spaced apart from the clamping body, wherein the release device is connected to the clamping body via an actuating element. For example, the clamping body can be arranged at one end of the one tube, and the release device can be arranged on the other end of the one tube. Due to the actuating element, it is then possible to engage or release the clamping device, even if it is located in the middle of the other tube.

Preferably, the release device has an actuating lever. The actuating lever can be pivoted in order to displace the clamping body. The actuation of an actuating lever is easily possible in single-handed operation.

It is preferred hereby for the actuating lever to be embodied or formed as a double-armed lever. One of the arms can be pivoted parallel to the longitudinal axis and the other arm can be pivoted perpendicular to the longitudinal axis. A user can then press on the arm that can be pivoted perpendicular to the longitudinal axis. This actuation then means that the other arm, which can be pivoted parallel to the longitudinal axis, pulls or pushes the clamping body, so that the clamping body displaces the rolling element or elements into the clamping position or releases the clamp.

Preferably, a return spring acts on the actuating lever. This return spring ensures that the clamping device becomes active when the user releases the actuating lever. It is thus ensured in a simple manner that the inner tube and the outer tube are fixed in their position relative to one another as soon as the user releases the actuating lever.

Embodiments of the invention are directed to a stand column. The stand column includes two tubes having longitudinal axes and curved tube walls surrounding the longitudinal axes. The two tubes include an inner tube guidable in a telescoping manner in an outer tube. A clamping device is structured and arranged to fix the inner tube in various positions with respect to the outer tube, and includes at least one rolling element with a rotational axis oriented parallel to a normal to the longitudinal axes. The at least one rolling element is positioned between at least one clamping body arranged on one of the two tubes and the other of the two tubes, and has a circumferential wall with a curvature parallel to the rotation axis that is adapted to a curvature of the other tube.

According to embodiments of the invention, the stand column may be structured and arranged as a music stand column or microphone stand column.

In accordance with aspects of the embodiments, the at least one clamping body can include several clamping bodies having circumferential walls that follow the curvature of the other tube.

According to further aspects of the embodiments, the other tube can have a circular cross section and the curvature of the circumferential wall of the rolling element can follow a circular line.

Further, the clamping body can have a mounting surface for each rolling element, and the mounting surface may be oriented at an acute angle to the longitudinal axis and can have a curvature adapted to the curvature of the circumferential surface of the rolling element.

In accordance with still other aspects, the one tube, on which the clamping body is positioned, or an insert connected thereto can form a holder for the rolling element.

According to further embodiments, the rolling element may be made of a plastic. The plastic may include polyurethane or has a same recovery behavior as polyurethane.

In accordance with other embodiments, the clamping body can be arranged on the inner tube and the rolling element can bear from inside against the outer tube.

According to still further embodiments, a release device may be connected to the clamping body and spaced apart from the clamping body and an actuating element can be structured and arranged to connect the release device to the clamping body. The release device may include an actuating lever, and the actuating lever can include a double-armed lever, in which one arm is pivotable parallel to the longitudinal axis and an other arm is pivotable perpendicular to the longitudinal axis. Further, a return spring may be structured and arranged to act on the actuating lever.

Embodiments of the invention are directed to a method of adjusting a telescoping column stand having at least two tubes. The method includes releasing a clamping force between at least one rolling element connected to one of the two tubes and a surface of an other of the two tubes, telescopically moving the one tube relative to the other tube, and applying a clamping force between the at least one rolling element and the surface of the other tube.

According to embodiments, the clamping force may be applied by a clamping device that can include at least one rolling element with a rotational axis oriented parallel to a normal to the longitudinal axes. The at least one rolling element may be positioned between at least one clamping body arranged on the one tube and the other tube, and can have a circumferential wall with a curvature parallel to the rotation axis that is adapted to a curvature of the other tube. The at least one clamping body may have a clamping surface oriented at an acute angle to a longitudinal axis of the other tube. In this manner, in applying the clamping force, the clamping surface can be moved to increase the pressure on the at least one element, and, in releasing the clamping force, the clamping surface can be moved to decrease the pressure on the at least one element. The releasing and applying may occur through an actuating element structured and arranged to connect a release device to the clamping body.

According to other aspects of the embodiments, the releasing, adjusting, and applying may be achieved through the use of only one hand of a user.

In accordance with still yet other embodiments of the invention, the telescoping stand column can include one of a music stand column, a microphone stand column, or a speaker stand column.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a music stand with stand column;

FIG. 2 illustrates a sectional view at the upper region of the stand column;

FIG. 3 illustrates a sectional view of a clamping device in the section according to FIG. 4; and

FIG. 4 illustrates a sectional view Iv-Iv according to FIG. 3.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

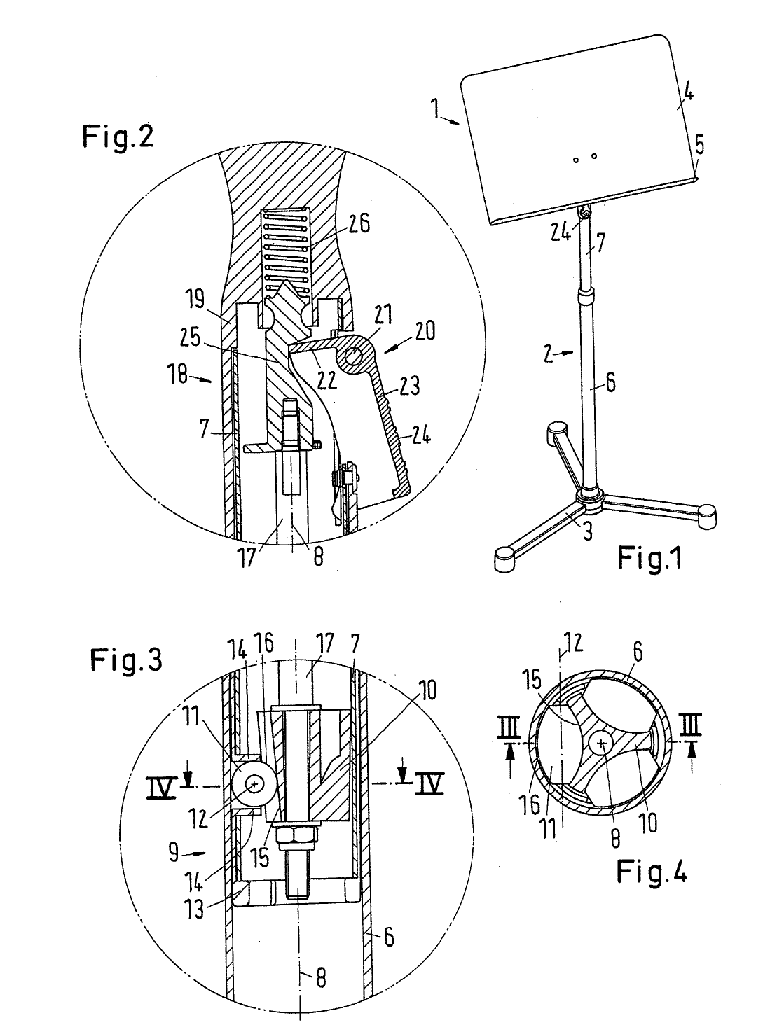

FIG. 1 shows a music stand 1 with a stand column 2. A foot 3, which is provided at the lower end of stand column 2, can include a number of supporting legs, e.g., three supporting legs as in the illustrated embodiment. A rest 4 for music is provided at an upper end of stand column 2, and includes a support ledge 5 at its lower edge.

It should be possible to adjust rest 4 to a height that is comfortable for a musician. To this end, stand column 2 includes an outer tube 6 and an inner tube 7. Both tubes 6 and 7 can have a circular cross section, such that both tubes 6 and 7 have curved tube walls, as can be seen with outer tube 6 in FIG. 4. In order to simplify the following explanation, a longitudinal axis 8 is defined, which forms the central axis of outer tube 6 and inner tube 7.

Inner tube 7 is inserted into outer tube 6 and is guided in outer tube 6 in a telescoping manner. In order to fix inner tube 7 in a predetermined alignment with respect to outer tube 6, a clamping device 9, which is illustrated in FIGS. 3 and 4, is provided.

Clamping device 9 has a clamping body 10, which in the present exemplary embodiment interacts with three rolling elements 11, which are pressed from inside against outer tube 6. Rolling elements 11 have a rotation axis 12, which is directed parallel to a normal to the longitudinal axis 8. The terms “perpendicular” and “parallel” are not to be understood in the mathematically exact sense here. Rolling elements 11 can be rotated to roll on the inner wall of outer tube 6. Rolling elements 11 are held in a holder 13 arranged at an end of inner tube 7. Holder 13 has, for example, holding flanges 14 directed radially inwards, which fix rolling elements 11 in a direction parallel to longitudinal axis 8 in holder 13.

Clamping body 10 has a mounting surface 15, which encloses an acute angle with longitudinal axis 8, as can be seen in FIG. 3. Otherwise, it has a curvature, which corresponds to the curvature of the inside of outer tube 6, but is directed in the opposite direction.

The rolling elements 11 are embodied in a “barrel-shaped” manner, i.e., they have a circumferential wall 16, which has a curvature in an axial direction, i.e., a direction parallel to the rotation axis 12. This curvature corresponds to the curvature of the inner wall of the outer tube 6 as well as to the curvature of the mounting surface 15. Accordingly, the rolling elements 11 are clamped virtually over their entire axial length between the outer tube 6 and the clamping body 10, when the clamping body 10 is moved in the direction towards the foot 3. The clamping effect results from the acute angle of the mounting surface 15, through which a spacing between the clamping body 10 and the outer tube 6 in the region of the rolling elements 11 is reduced further, as the clamping body 10 is displaced in the direction towards the foot 3.

Rolling element 11 is made of a plastic, preferably a polyurethane or a plastic with the same or with a similar recovery behavior as polyurethane. This means that rolling element 11 can be deformed somewhat when a correspondingly large clamping force is applied. In this way, not only does it form linear contact zones with outer tube 6 and clamping body 10, but these linear contact zones also expand to form surfaces. The clamping forces can thus be made correspondingly large without having to make the compressive stresses between outer tube 6 and rolling element 11 too large. Therefore, there is no danger that outer tube 6 is deformed by rolling element 11. When the clamping force is reduced, for example, by moving clamping body 10 away from foot 3, rolling elements 11 take on their “barrel-shaped” form again shown in FIG. 4, i.e., they again achieve a circular cross section at every point of their axial extension, so that they can roll on the inside of outer tube 6 during a subsequent shift of inner tube 7 relative to outer tube 6.

While the illustrated outer tube 6 has a circular cross section, this is not absolutely necessary, as other curved cross sections can also be used. However, with these alternatives, the curvature of circumferential wall 16 of the respective rolling element 11 should be adapted to the curvature of the inner wall of outer tube 6.

Rolling elements 11 can also be provided with a “negative” barrel shape (in a manner not shown), so that in their axial center they have a smaller diameter than at their axial ends. In this case, rolling elements 11 would act from outside on inner tube 7 and clamping body 10 would be arranged on outer tube 6. However, the embodiment shown in FIGS. 3 and 4 is more space-saving.

Clamping body 10 is connected via an actuating element 17 to a release device 18, which is shown in FIG. 2. Release device 18 is arranged in a stand column head 19, which is connected to the end of inner tube 7 that is not inserted into outer tube 6.

Release device 18 has an actuating lever 20, which can be pivoted about a pivot axis 21. Actuating lever 20 is embodied or formed as a double-armed lever with a first arm 22, which can be pivoted parallel to longitudinal axis 8. A swivel motion is naturally not parallel to an axis in the mathematically exact sense. What is meant is that the end of first arm 22 can move away from foot 3 or towards foot 3 with a pivoting of actuating lever 20.

Furthermore, an actuating lever 20 has a second arm 23, which forms an actuating surface 24. Second arm 23 can be pivoted essentially in a perpendicular manner to longitudinal axis 8, so that a user can act on it, for example, with his thumb in order to press it in.

First arm 22 of actuating lever 20 interacts with an end piece 25 that is arranged on actuating element 17. When second arm 23 is pivoted towards longitudinal axis 8, first arm 22 of actuating lever 20 moves end piece 25 in a direction away from foot 3. This movement is transferred with the aid of actuating element 17 to clamping body 10, which then reduces the clamping force on rolling elements 11. In this manner, the friction between rolling elements 11 and outer tube 6 is virtually eliminated. A user can then displace inner tube 7 in outer tube 6 as desired.

A return spring 26 acts on end piece 25 and thus on actuating lever 20. Therefore, when the user releases actuating lever 20, return spring 26 presses clamping element 10 via actuating element 17 as far as possible in the direction of foot 3. Thus, rolling elements 11 are clamped between clamping body 10 and outer tube 6. The friction force produced thereby fixes inner tube 7 relative to outer tube 6.

The height adjustment of rest 4 can be carried out by a single-handed operation. A user grips inner tube 7 with his hand in the region of release device 18 and then presses on actuating surface 24 with the thumb of the hand. Clamping device 9 is thereby released. The user can then change the height of inner tube 7 relative to outer tube 6 with the same hand. As soon as the user releases actuating surface 24, inner tube 7 is fixed with respect to outer tube 6. This fixing entails a fixing in a direction parallel to longitudinal axis 8, while inner tube 7 is also secured by the clamping of rolling elements 11 against a twisting with respect to outer tube 6.

The stand column can also be used for other purposes, for example, with a speaker stand for loudspeakers.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A stand column comprising:
two tubes having longitudinal axes and curved tube walls surrounding the longitudinal axes, the two tubes including an inner tube guidable in a telescoping manner in an outer tube;
a clamping device, structured and arranged to fix the inner tube in various positions with respect to the outer tube, and comprising at least one rolling element with a rotational axis oriented parallel to a normal to the longitudinal axes; and
the at least one rolling element being positioned between at least one clamping body arranged on one of the two tubes and the other of the two tubes, and having a circumferential wall with a curvature parallel to the rotation axis that is adapted to a curvature of the other tube.

2. The stand column in accordance with claim 1, which is structured and arranged as a music stand column or microphone stand column.

3. The stand column in accordance with claim 1, wherein the at least one clamping body comprises several clamping bodies having circumferential walls that follow the curvature of the other tube.

4. The stand column in accordance with claim 1, wherein the other tube has a circular cross section and the curvature of the circumferential wall of the rolling element follows a circular line.

5. The stand column in accordance with claim 1, wherein the clamping body has a mounting surface for each rolling element, and the mounting surface is oriented at an acute angle to the longitudinal axis and has a curvature that is adapted to the curvature of the circumferential surface of the rolling element.

6. The stand column in accordance with claim 1, wherein the one tube, on which the clamping body is positioned, or an insert connected thereto forms a holder for the rolling element.

7. The stand column in accordance with claim 1, wherein the rolling element is made of a plastic.

8. The stand column in accordance with claim 7, wherein the plastic comprises polyurethane or has a same recovery behavior as polyurethane.

9. The stand column in accordance with claim 1, wherein the clamping body is arranged on the inner tube and the rolling element bears from inside against the outer tube.

10. The stand column in accordance with claim 1, further comprising a release device connected to the clamping body and spaced apart from the clamping body; and
an actuating element structured and arranged to connect the release device to the clamping body.

11. The stand column in accordance with claim 10, wherein the release device comprises an actuating lever.

12. The stand column in accordance with claim 11, wherein the actuating lever comprises a double-armed lever, in which one arm is pivotable parallel to the longitudinal axis and an other arm is pivotable perpendicular to the longitudinal axis.

13. The stand column in accordance with claim 11, further comprising a return spring structured and arranged to act on the actuating lever.

14. A method of adjusting a telescoping column stand having at least two tubes, comprising:
releasing a clamping force between at least one rolling element connected to one of the two tubes and a surface of an other of the two tubes;
telescopically moving the one tube relative to the other tube;
applying a clamping force between the at least one rolling element and the surface of the other tube.

15. The method in accordance with claim 14, wherein the clamping force is applied by a clamping device comprising at least one rolling element with a rotational axis oriented parallel to a normal to the longitudinal axes.

16. The method in accordance with claim 15, wherein the at least one rolling element is positioned between at least one clamping body arranged on the one tube and the other tube, and has a circumferential wall with a curvature parallel to the rotation axis that is adapted to a curvature of the other tube.

17. The method in accordance with claim 16, wherein the at least one clamping body has a clamping surface oriented at an acute angle to a longitudinal axis of the other tube, whereby, in applying the clamping force, the clamping surface is moved to increase the pressure on the at least one element, and, in releasing the clamping force, the clamping surface is moved to decrease the pressure on the at least one element.

18. The method in accordance with claim 17, wherein the releasing and applying occur through an actuating element structured and arranged to connect a release device to the clamping body.

19. The method in accordance with claim 14, wherein the releasing, adjusting, and applying are achieved through the use of only one hand of a user.

20. The method in accordance with claim 14, wherein the telescoping stand column comprises one of a music stand column, a microphone stand column, or a speaker stand column.
